(19) United States
(12) Patent Application Publication
(10) Pub. No.: US 2026/0037751 A1
(43) Pub. Date: Feb. 5, 2026

(54) TEXT GENERATION SYSTEM AND TEXT GENERATION METHOD

(71) Applicant: SEMICONDUCTOR ENERGY LABORATORY CO., LTD., Atsugi-shi (JP)

(72) Inventors: Junpei MOMO, Sagamihara (JP); Natsuko TAKASE, Isehara (JP)

(21) Appl. No.: 19/280,280

(22) Filed: Jul. 25, 2025

(30) Foreign Application Priority Data
Jul. 30, 2024 (JP) 2024-123610

(51) Int. Cl. G06F 40/40; G06F 16/335

(52) U.S. Cl. CPC G06F 40/40; G06F 16/335

(57) ABSTRACT

A text generation system that supports understanding of both an inventor and a patent engineer and supports creation of appropriate claims for the invention in patent application. The text generation system is configured to perform processing using a language model, create a key point of the invention from material of the invention, create a claim proposal from the key point of the invention, and create a search formula from the claim proposal. In addition, the text generation system is configured to perform a patent search with use of the search formula.

### BACKGROUND OF THE INVENTION

### 1. Field of the Invention

The present invention relates to a text generation system and a text generation method utilizing a language model, particularly, a generative AI model.

Note that one embodiment of the present invention is not limited to the above technical field. Examples of the technical field of one embodiment of the present invention disclosed in this specification and the like include a semiconductor device, a display device, a light-emitting device, a power storage device, a memory device, an electronic device, a lighting device, an input device, an input/output device, a driving method thereof, and a manufacturing method thereof. A semiconductor device generally means a device that can function by utilizing semiconductor characteristics.

### 2. Description of the Related Art

In recent years, language models using neural networks have been actively developed, and especially large language models (LLM) have attracted attention. An LLM is a natural language processing model learned using a large amount of data. With an LLM, for example, a conversational model that gives an answer to a user's instruction can be achieved. In Non-Patent Document 1, generative pre-trained transformer 4 (GPT-4, registered trademark) is disclosed as an LLM, and ChatGPT is disclosed as a conversational model.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

For patent application, the inventor can describe the technical content of his or her invention; however, in order to clearly state the technical content of the invention in claims without any excessiveness or insufficiency, help of a patent engineer is needed. On the other hand, it is difficult for a patent engineer to fully understand the invention because his or her background knowledge of the technical content of the invention is insufficient.

In view of the above problems, an object of the present invention is to support understanding of both the inventor and the patent engineer about the invention and to support creation of appropriate claims for the invention.

Note that the description of these objects does not preclude the existence of other objects. One embodiment of the present invention does not need to achieve all these objects. Objects other than these can be derived from the description of the specification, the drawings, the claims, and the like.

In view of the above problems, one embodiment of the present invention is a text generation system including a first data processing device, a second data processing device, and a third data processing device. The first data processing device is configured to receive at least a first instruction sentence, a second instruction sentence, and a third instruction sentence, perform processing using a language model, and output at least a first answer sentence, a second answer sentence, and a third answer sentence. The second data processing device is configured to receive a search formula, perform a patent search, and output a patent search result. The third data processing device is configured to: receive material of the invention; create the first instruction sentence from the material of the invention; transmit the first instruction sentence to the first data processing device and receive the first answer sentence including a key point of the invention; output the key point of the invention; create the second instruction sentence from the material of the invention and the key point of the invention; transmit the second instruction sentence to the first data processing device and receive a second answer sentence including a claim proposal; create the third instruction sentence from the claim proposal; transmit the third instruction sentence to the first data processing device; receive the third answer sentence including the search formula; and transmit the search formula to the second data processing device and receive the patent search result.

In the above text generation system, the third data processing device is configured to: perform a search on the material of the invention for content of the invention and obtain a search result of the material of the invention; create a fourth instruction sentence from the search result of the material of the invention; transmit the fourth instruction sentence to the first data processing device and receive a fourth answer sentence including element information of the invention from the first data processing device; accumulate the element information of the invention; and create the key point of the invention from the element information of the invention.

In the above text generation system, it is preferable that the third data processing device be configured to: create a fifth instruction sentence from the claim proposal; transmit the fifth instruction sentence to the first data processing device and receive a fifth answer sentence including a search element and a component from the first data processing device; and optimize the claim proposal with use of combination optimization of the search element and the component.

In the above text generation system, it is preferable that the third data processing device be configured to: create a fifth instruction sentence from the claim proposal; transmit the fifth instruction sentence to the first data processing device and receive the fifth answer sentence including a component and a search element from the first data processing device; create a sixth instruction sentence from a pair of the component and the search element and the number of patent search results searched with the search element; and transmit the sixth instruction sentence to the first data processing device and receive a sixth answer sentence including the optimized claim proposal from the first data processing device.

Furthermore, one embodiment of the present invention is a text generation method including a first step, a second step, a third step, a fourth step, a fifth step, a sixth step, a seventh step, an eighth step, a ninth step, a tenth step, and an eleventh step. In the first step, material of the invention is received. In the second step, a first instruction sentence is created from the material of the invention. In the third step, the first instruction sentence is input to a language model and a first answer sentence including a key point of the invention is obtained. In the fourth step, the key point of the invention is output to a user. In the fifth step, the key point of the invention modified by the user is received. In the sixth step, a second instruction sentence is created using the modified key point of the invention. In the seventh step, the second instruction sentence is input to the language model and a second answer document including a claim proposal is obtained. In the eighth step, a third instruction sentence is created from the claim proposal. In the ninth step, the third instruction sentence is input to the language model and a third answer document including a search formula is obtained. In the tenth step, the search formula is input to a search server and a patent search result is obtained. In the eleventh step, the patent search result and the claim proposal is output to the user. The first step, the second step, the third step, the fourth step, the fifth step, the sixth step, the seventh step, the eighth step, the ninth step, the tenth step, and the eleventh step are executed in the above order by a processing portion.

In the above text generation method, it is preferable that a twelfth step be included. It is preferable that the twelfth step be executed after the tenth step. It is preferable that in the twelfth step, whether the number of documents of of the patent search result is within a predetermined range be determined, and a process return to the eighth step when the number of documents of the patent search result is not within the predetermined range, and the process proceed to the eleventh step when the number of documents of the patent search result is within the predetermined range.

In the above text generation method, it is preferable that a thirteenth step be included. It is preferable that the thirteenth step be executed after the eleventh step. It is preferable that in the thirteenth step, the user confirm the patent search result and the claim proposal, and a process return to the fifth step when modification of the claim proposal is necessary, and execution of the steps is terminated when modification of the claim proposal is not necessary.

In the above text generation method, it is preferable that a fourteenth step, a fifteenth step, a sixteenth step, a seventeenth step, an eighteenth step, and a nineteenth step be included instead of the second step, the third step, and the fourth step. It is preferable that in the fourteenth step, a search for the material of the invention using a question regarding content for the invention be performed and a search result of the material of the invention be obtained. It is preferable that in the fifteenth step, a fourth instruction sentence be created from the search result of the material of the invention. It is preferable that in the sixteenth step, the fourth instruction sentence be input to the language model and a fourth answer sentence including element information of the invention be obtained. It is preferable that in the seventeenth step, the element information of the invention be accumulated. It is preferable that in the eighteenth step, the fourteenth step, the fifteenth step, the sixteenth step, and the seventeenth step be repeated until the final question. It is preferable that in the nineteenth step, the accumulated element information of the invention be output as the key point of the invention.

In the above text generation method, it is preferable that a twentieth step, a twenty-first step, and a twenty-second step be included after the eleventh step. It is preferable that in the twentieth step, a fifth instruction sentence be created from the claim proposal. It is preferable that in the twenty-first step, the fifth instruction sentence be input to the language model and a fifth answer sentence including a search element and a component be obtained. It is preferable that in the twenty-second step, the claim proposal be optimized with use the of combination optimization of the search element and the component.

In the above text generation method, it is preferable that a twenty-third step and a twenty-fourth step be included instead of the twenty-second step. It is preferable that in the twenty-third step, a sixth instruction sentence be created from a pair of the component and the search element, and the number of patent search results searched with the search element. It is preferable that in the twenty-fourth step, the sixth instruction sentence be input to the language model and a sixth answer sentence including the optimized claim proposal be obtained.

According to one embodiment of the present invention, it is possible to support understanding of both the inventor and the patent engineer about the invention and to support creation of appropriate claims for the invention. Furthermore, an appropriate patent search can be performed for the invention.

Note that the description of these effects does not preclude the existence of other effects. Note that one embodiment of the present invention does not need to have all the effects. Effects other than these can be derived from the description of the specification, the drawings, the claims, and the like.

### BRIEF DESCRIPTION OF THE DRAWINGS

FIG. 1 is a schematic diagram illustrating a structure example of a text generation system.

FIG. 2 is a block diagram illustrating a structure example of a text generation system.

FIG. 3 is a flowchart showing an example of a text generation method.

FIG. 4 is a flowchart showing an example of a text generation method.

FIG. 5 is a flowchart showing an example of a text generation method.

FIG. 6 is a flowchart showing an example of a text generation method.

FIG. 7 is a flowchart showing an example of a text generation method.

FIG. 8 is a flowchart showing an example of a text generation method.

FIG. 9 is a flowchart showing an example of a text generation method.

### DETAILED DESCRIPTION OF THE INVENTION

Embodiments will be described below with reference to the drawings. Note that the embodiments can be implemented with many different modes, and it will be readily understood by those skilled in the art that modes and details thereof can be changed in various ways without departing from the spirit and scope thereof. Therefore, the present invention should not be construed as being limited to the description of embodiments below.

Note that in structures of the invention described below, the same portions or portions having similar functions are denoted by the same reference numerals in different drawings, and the description thereof is not repeated. Furthermore, portions having similar functions are not denoted by specific reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that in this specification and the like, ordinal numbers such as “first” and “second” are used in order to avoid confusion among components and do not limit the number of components. The ordinal numbers do not denote the priority or the order such as the order of steps or the stacking order. A term without an ordinal number in this specification and the like might be provided with an ordinal number in a claim in order to avoid confusion among components. A term with an ordinal number in this specification and the like may be described with a different ordinal number in a claim. A term with an ordinal number in this specification and the like may be described without an ordinal number in a claim.

Note that in this specification and the like, a language model is an interactive (also referred to as conversational) model based on a transformer architecture and obtained by additional learning. A typical language model is a large language model (LLM). The LLM performs processing based on supplied text data, specialized for a text generation function, and generative AI has not only the text generation function but also an image generation function based on image data. That is, the large language model is one kind of generative AI.

### Embodiment 1

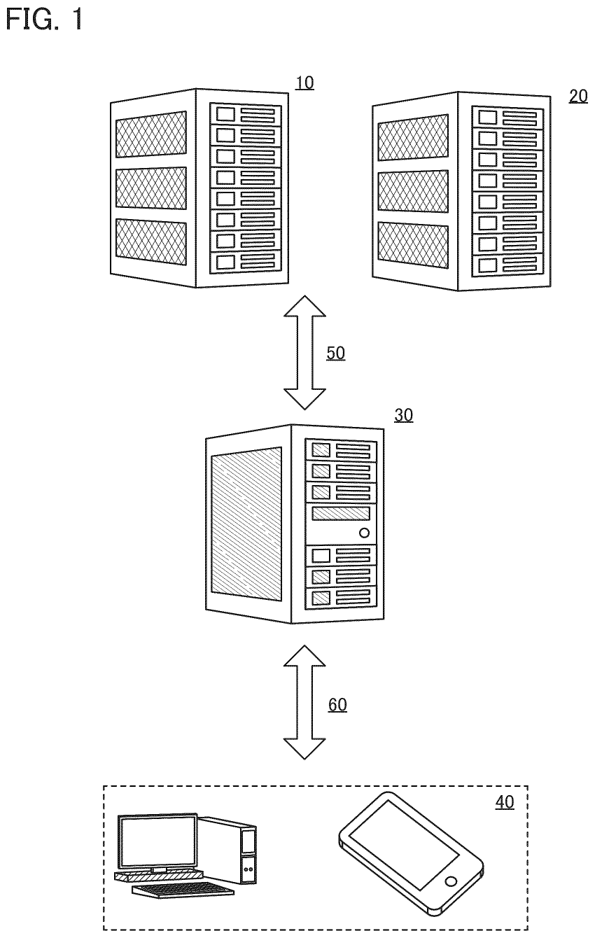

In this embodiment, a structure example of a text generation system of one embodiment of the present invention is described with reference to FIG. 1.

In the text generation system and a text generation method of one embodiment of the present invention, a key point of the invention is output from material of the invention of a user with the use of a language model. Furthermore, creating a claim proposal from the key point of the invention and performing a patent search can support description of claims of the invention and an appropriate patent search for invention.

More specific examples are described below with reference to drawings.

### Structure Example 1 of Text Generation System

As illustrated in FIG. 1, the text generation system of this embodiment preferably includes a first data processing device 10, a second data processing device 20, a third data processing device 30, and an information terminal 40. The third data processing device 30 is connected to the first data processing device 10 and the second data processing device 20 through a network 50. The third data processing device 30 is connected to the information terminal 40 through a network 60.

In the text processing device of this embodiment, the device structure in FIG. 1 is one example; third data processing device 30 may have a function of at least one of the first data processing device and the second data processing device, and a function of the third data processing device 30 can be dispersedly implemented in a plurality of data processing devices.

### <<Structure Example of Information Terminal>>

In Structure example 1 of text generation system, the information terminal 40 is operated by a user and can be referred to as a client computer or the like. Although a desktop computer and a smartphone are illustrated as examples in FIG. 1, a laptop computer or a tablet computer may be used as the information terminal 40. A tablet computer may be used by connecting to a housing including an input portion (typically, a keyboard).

### <<Structure Example of First Data Processing Device 10>>

Next, a structure example of the first data processing device 10 is described.

The first data processing device 10 can perform processing using a language model. In particular, the first data processing device 10 can perform processing using a model utilizing a large language model (a text generation model, an interactive model, or the like). For example, processing can be executed using large language models such as GPT-4, Llama2, and Llama3. Note that in this specification and the like, the language model includes the large language model.

The first data processing device 10 has a function of outputting an answer sentence to an instruction sentence with the use of the language model, and can execute a variety of natural language tasks such as translating and summarizing.

A service provider using the text generation system of one embodiment of the present invention does not necessarily have his or her own first data processing device 10. For example, the service provider can use part of the service that is provided by another company or the like as the first data processing device 10.

### <<Structure Example of Second Data Processing Device 20>>

The second data processing device 20 has a function of receiving a search formula and searching for a patent.

In this specification, “search” refers to finding text data with high relevance from a plurality of pieces of text data.

In the search, an index may be created from a plurality of pieces of text data. “Index” refers to an index created from text data. By creating the index, a search can be performed at high speed.

In the search, text data may be converted into vector data to obtain the degree of similarity between a pieces of vector data. “Vector data” refers to multidimensional arrangement composed of numerical values of 0 to 9 with respect to text data composed of a character string (natural language) such as text. The vector data can also be regarded as data in a format capable of arithmetic processing. Specific methods for converting text data into vector data include Bag of Words, distributed representations, embedded representations, and the like. As an example of an indicator representing the degree of similarity between the pieces of vector data, cosine similarity can be given.

In this specification, a “search formula” is a character string including at least a search word. The search formula may include a plurality of search words. The search formula may include a search condition, a classification code, or the like.

The service provider using the text generation system of one embodiment of the present invention does not necessarily have his or her own second data processing device 20. For example, the service provider can use part of the service that is provided by another company or the like as the second data processing device 20.

### <<Structure Example of Third Data Processing Device 30>>

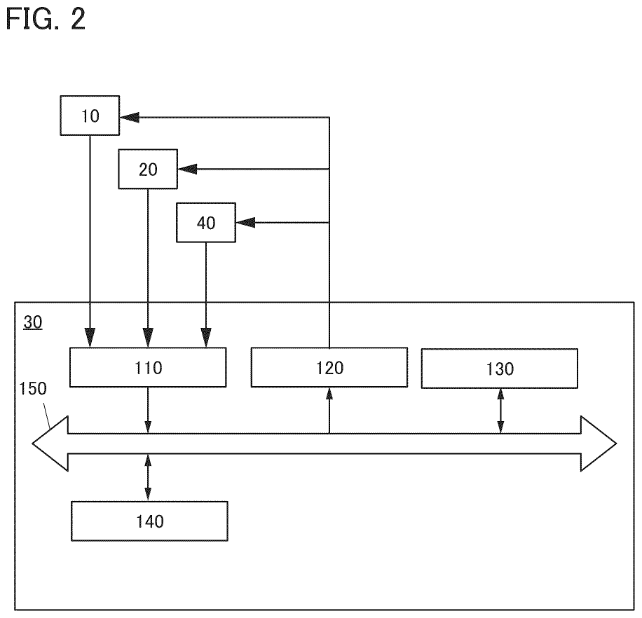

Next, a structure example of the third data processing device 30 is described with reference to FIG. 2.

As illustrated in FIG. 2, the third data processing device 30 includes a reception portion 110, an output portion 120, a memory portion 130, a processing portion 140, and a transmission path 150. FIG. 2 illustrates the second data processing device 20 and the information terminal 40 in addition to the first data processing device 10, and arrows indicate data transmission and reception. The reception portion and the output portion are collectively referred to as a communication portion in some cases. With the communication portion, the third data processing device 30 can transmit and receive data to and from the outside.

### [Reception Portion 110]

The reception portion 110 has a function of receiving data from the outside. For example, the reception portion 110 can receive the answer sentence from the first data processing device 10. As the reception portion 110, a communication port or an input device such as a personal computer having a communication function may be used, for example.

Data received from the first data processing device 10 by the reception portion 110 is, for example, the key point of the invention output from the language model.

The reception portion 110 can supply the received data to one or more selected from the memory portion 130 and the processing portion 140 through the transmission path 150.

### [Output Portion 120]

The output portion 120 has a function of outputting an arithmetic result or the like to the outside. For example, the output portion 120 can transmit the instruction sentence to the first data processing device 10. As the output portion 120, a communication port or a device such as a personal computer having a communication function may be used, for example.

### [Memory Portion 130]

The memory portion 130 has a storage function. The memory portion 130 is a memory region and can store a program program and/or data, for example. A typical example of the program is a program executed by the processing portion 140. The data includes data received by the reception portion 110 (e.g., the material of the invention and the patent search result). In addition, the data includes data generated by the language model (e.g., the key point of the invention and the claim proposal).

The memory portion 130 may include a database. The first data processing device 10 may include another database in addition to the memory portion 130. The first data processing device 10 may have a function of extracting data from a database outside of the memory portion 130, outside of the first data processing device 10, or outside of the data processing system. Alternatively, the first data processing device 10 may have a function of extracting data from both of its own database and an external database.

One or both of a storage and a file server can be used as the memory portion 130. In addition, a database in which a path of a file stored in the file server is recorded can be used as the memory portion 130.

The memory portion 130 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The memory portion 130 may include at least one of a NOSRAM (registered trademark) and a DOSRAM (registered trademark). The memory portion 130 may include a recording media drive. Examples of the recording media drive include a hard disk drive (HDD) and a solid state drive (SSD).

Note that the NOSRAM is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM can be used as a nonvolatile memory by retaining electric charge corresponding to data in memory cells, using characteristics of extremely low leakage current. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for “dynamic oxide semiconductor RAM” and refers to a RAM including a one-transistor (1T) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide can be suitably used as the metal oxide included in the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases. For example, indium gallium zinc oxide (also referred to as IGZO) or indium tin oxide (also referred to as ITZO (registered trademark)) can be used as the metal oxide included in the channel formation region.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide and gallium tin oxide).

### [Processing Portion 140]

The processing portion 140 has a function of performing processing such as arithmetic operation and analysis with use of data supplied from one or both of the reception portion 110 and the memory portion 130. The processing portion 140 can supply processed data to one or both of the memory portion 130 and the output portion 120.

The processing portion 140 can include an arithmetic circuit, for example. The processing portion 140 can include a central processing unit (CPU), for example. The processing portion 140 can include a graphics processing unit (GPU) in addition to or instead of the CPU. Furthermore, the processing portion 140 can include a neural processing unit/neural network processing unit (NPU).

The processing portion 140 may include a register and a main memory in addition to the CPU. The register and the main memory are sometimes included in the CPU. The main memory can transmit and receive data to and from the secondary cache or the like. The main memory includes at least one of a volatile memory such as a random access memory (RAM) and a nonvolatile memory such as a read only memory (ROM). The main memory may include at least one of a NOSRAM and a DOSRAM. The main memory can include one or both of an OS transistor and a Si transistor. Note that the structures of the register and the main memory can be understood by replacing the CPU in this paragraph with the GPU.

Examples of the RAM include a DRAM and an SRAM. In a DRAM or an SRAM, a virtual memory space can be assigned and utilized as a working space of the processing portion 140. An operating system, an application program, a program module, program data, a look-up table, and the like which are stored in the memory portion 130 are loaded into the RAM immediately before execution. The operating system, the application program, the program module, the program data, and the look-up table which are loaded into the RAM can be accessed from the processing portion 140.

A system that does not require rewriting or the like can be stored in the ROM. As the system that does not require rewriting, firmware such as a basic input/output system (BIOS) can be given. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing portion 140 may include a microprocessor such as a digital signal processor (DSP) in addition to the CPU or the GPU. The DSP is specialized in digital signal processing and is thus preferably included to control a peripheral circuit and the like of the CPU or the GPU. The microprocessor may be configured with a programmable logic device (PLD), which is operated by hardware, such as a field programmable gate array (FPGA) or a field programmable analog array (FPAA).

The third data processing device 30 has a function of creating an instruction sentence from text data with the use of the processing portion 140. Specifically, the processing portion 140 has a function of creating a first instruction sentence from the material of the invention, a function of creating a second instruction sentence from the key point of the invention, a function of creating a third instruction sentence from the claim proposal, and the like.

The third data processing device 30 may have a function of searching the material of the invention for content of the invention with the use of processing portion 140 and creating a fourth instruction sentence from the search result of the material of the invention.

### [Transmission Path 150]

The transmission path 150 has a function of transmitting data. Data transmission and reception among the reception portion 110, the output portion 120, the memory portion 130, and the processing portion 140 can be performed through the transmission path 150. As the transmission path 150, for example, an external bus, a local area network (LAN), and the Internet, which is the infrastructure of the World Wide Web (WWW), may be used.

### Example of Text Generation Method

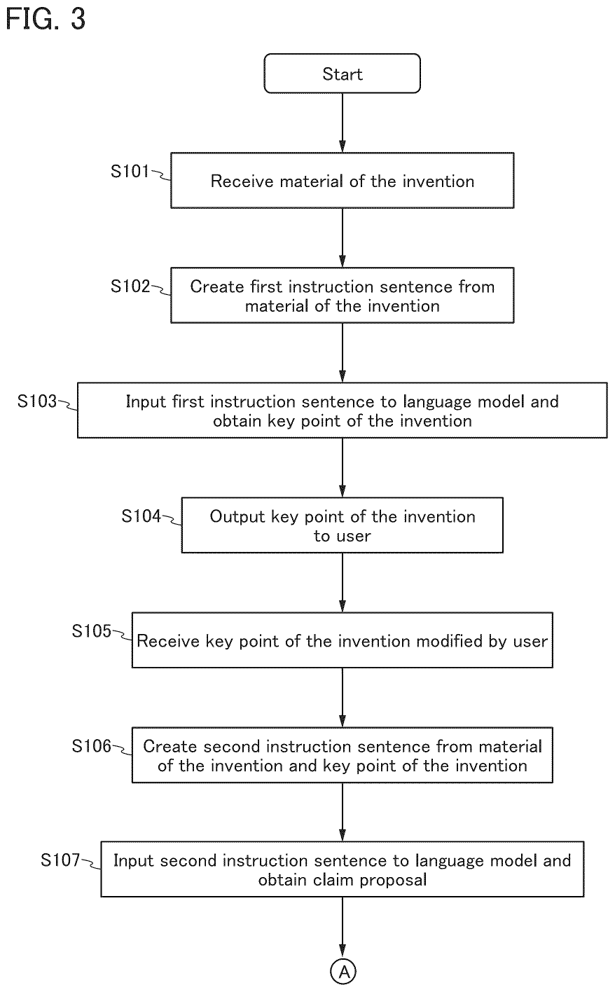

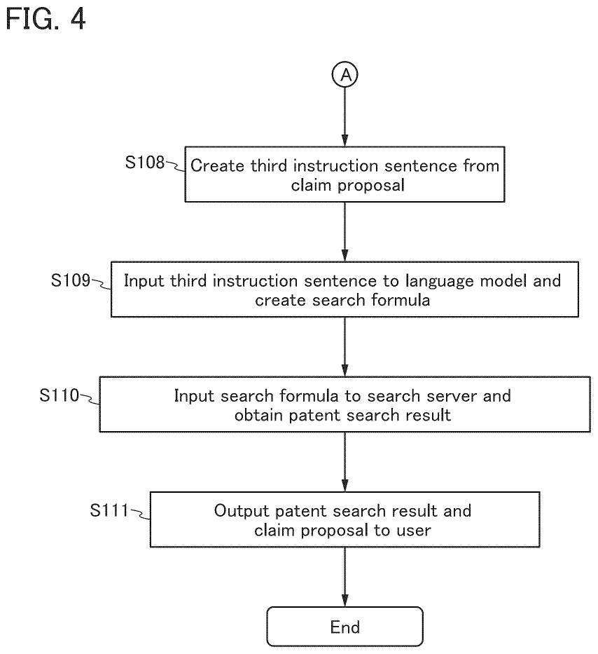

FIG. 3 and FIG. 4 each show an example of a flowchart of steps relating to the text generation method of one embodiment of the present invention.

### Step 101

In Step S101, the third data processing device 30 receives material of the invention from a user.

The material of the invention is a collection of materials, data, and the like relating to the invention. An experimental report on the invention can be given, for example. Furthermore, at least one of a technical field, a problem, an effect, a specific example, and the like is preferably included in the material of the invention.

The input work by the user corresponding to Step S101 is performed by the information terminal 40. The material of the invention is transmitted to the third data processing device 30 through the reception portion 110 and stored in the memory portion 130.

### Step S102

In Step S102, the third data processing device 30 creates the first instruction sentence from the material of the invention in the processing portion 140.

An instruction sentence is an input sentence for making a language model perform a desired operation, and the language model generates an answer sentence on the basis of the instruction sentence. The first instruction sentence is a character string for making the language model generate a key point of the invention. Examples of the first instruction sentence include a character string “extract a key point of the invention from the following material of the invention” and a character string including the material of the invention.

### Step S103

In Step S103, the third data processing device 30 transmits the first instruction sentence to the first data processing device 10 through the output portion 120. The first data processing device 10 inputs the first instruction sentence to the language model and generates the first answer sentence including the key point of the invention. The third data processing device 30 obtains the first answer sentence through the reception portion 110.

### Step S104

In Step S104, the third data processing device 30 transmits the key point of the invention to the information terminal 40 through the output portion 120, and the information terminal 40 displays the key point of the invention to the user.

### Step S105

In Step S105, the third data processing device 30 obtains the key point of the invention from the information terminal 40 through the reception portion 110. Here, the user may modify the key point of the invention if necessary.

### Step S106

In Step S106, the third data processing device 30 creates the second instruction sentence from the material of the invention and the key point of the invention in the processing portion 140.

The second instruction sentence is a character string for making the language model generate a claim proposal. Examples of the second instruction sentence include a character string “generate a claim proposal from the following material of the invention and the key point of the invention” and a character string including the material of the invention and the key point of the invention.

### Step S107

In Step S107, the third data processing device 30 transmits the second instruction sentence to the first data processing device 10 through the output portion 120. The first data processing device 10 inputs the second instruction sentence to the language model and generates a second answer sentence including the claim proposal. The third data processing device 30 obtains the second answer sentence through the reception portion 110.

In Step S107, the second answer sentence preferably includes a corresponding table of components of the claim proposal and corresponding portions of the material of the invention. This has an effect of making it easier for both the inventor and the patent engineer to understand the contents of the claim proposal.

### Step S108

In Step S108, the third data processing device 30 creates the third instruction sentence from the claim proposal in the processing portion 140.

The third instruction sentence is a character string for making the language model to generate a search formula. Examples of the third instruction sentence include a character string “generate a search formula related to a patent from the following claims” and a character string including the claim proposal.

### Step S109

In Step S109, the third data processing device 30 transmits the third instruction sentence to the first data processing device 10 through the output portion 120. The first data processing device 10 inputs the third instruction sentence to the language model and generates a third answer sentence including the search formula. The third data processing device 30 obtains the third answer sentence through the reception portion 110.

### Step S110

In Step S110, the third data processing device 30 transmits the search formula to the second data processing device 20 through the output portion 120. The second data processing device 20 inputs the search formula to a search server to obtain the patent search result. The third data processing device 30 obtains a patent search result through the reception portion 110. The patent search result is a list of documents, e.g., a list of patent numbers.

The patent search result obtained in Step S110 is preferably stored in the memory portion 130.

### Step S111

In Step S111, the third data processing device 30 transmits the claim proposal and the patent search result to the information terminal 40 through the output portion 120, and the information terminal 40 displays the claim proposal and the patent search result to the user.

The text generation method of one embodiment of the present invention can be terminated after Step S111.

With the use of such a text generation method, a claim proposal that can be easily understood by both the inventor and the patent engineer can be created, and a patent search result useful for the invention can be obtained.

### Variation Example 1 of Text Generation Method

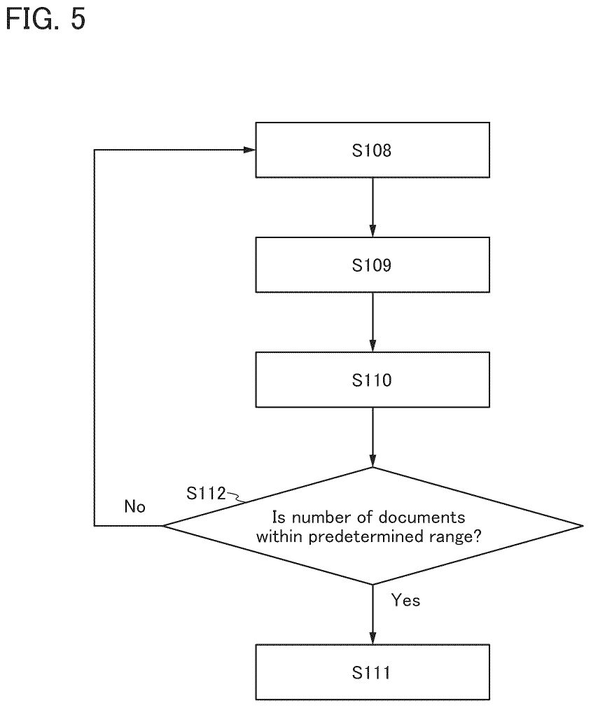

FIG. 5 is a flowchart of a variation example of the text generation method. In FIG. 5, Step S112 is added between Step S110 and Step S111.

### Step S112

In Step S112, the third data processing device 30 determines whether the number of documents is within a predetermined range in the patent search result obtained in Step S110, and the process proceeds to Step S111 when the number of documents is within the predetermined range, and the process returns to Step S108 when the number of documents is outside the predetermined the range.

When the process returns to Step S108, the third data processing device 30 newly creates the third instruction sentence from the claim proposal in the processing portion 140. In this case, the search formula or the third answer sentence including the search formula obtained in Step S109 is preferably added to the third instruction sentence. For example, in the case where the number of documents is larger than a predetermined range in the patent search result, an instruction for generating a search formula whose search range is limited as compared with that of the search formula is preferably added. For example, in the case where the number of documents is smaller than the predetermined range, an instruction for generating a search formula whose search range is expanded as compared with that of the search formula is preferably added to the search formula.

In Step S112, the range serving as a determination criterion is preferably set by the user.

### Variation Example 2 of Text Generation Method

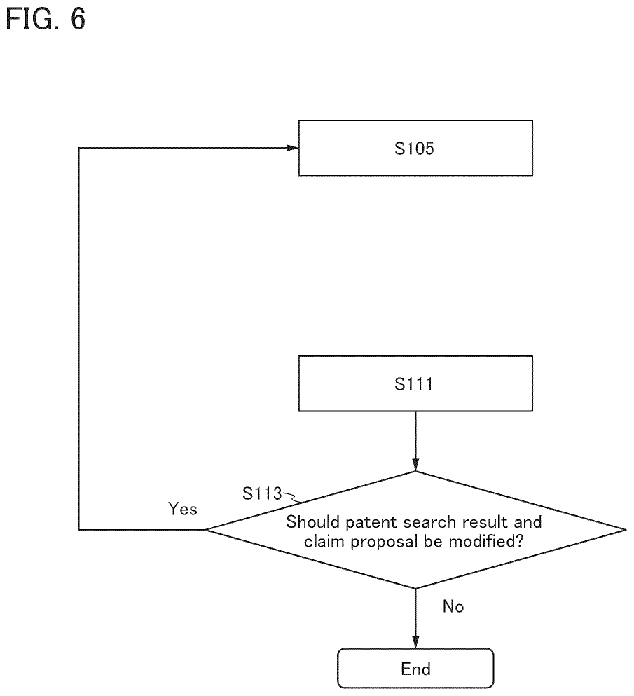

FIG. 6 is a flowchart of a variation example of the text generation method. In FIG. 6, Step S113 is added after Step S111.

### Step S113

In Step S113, the third data processing device 30 receives the user's confirmation result of the patent search result and the claim proposal output in Step S111 through the reception portion 110. In the case where the user determines that it is necessary to modify the key point of the invention, the process returns to Step S105, and in the case where the user determines that it is unnecessary to modify the key point of the invention, the process is terminated after Step S113.

### Variation Example 3 of Text Generation Method

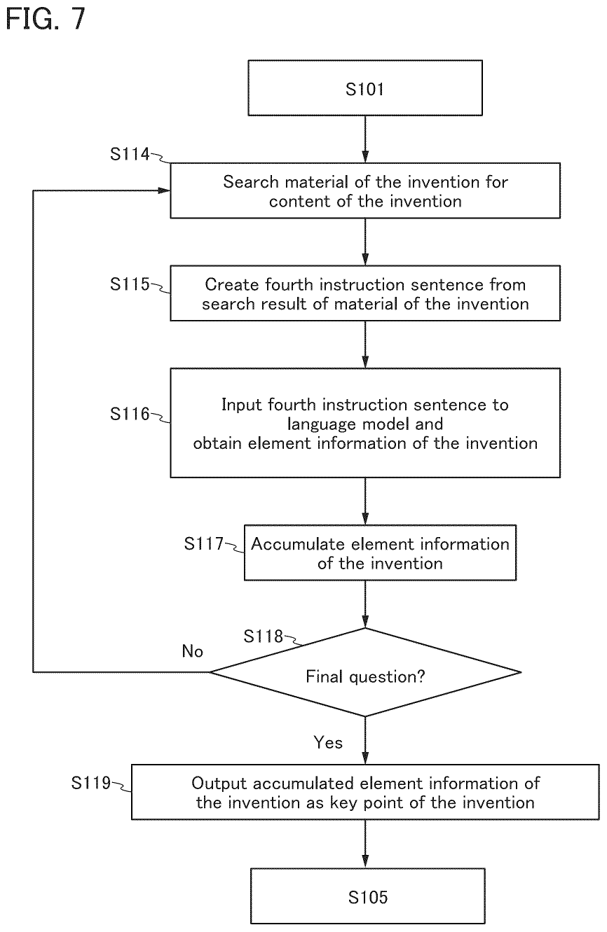

FIG. 7 is a flowchart of a variation example of the text generation method. In FIG. 7, Step S114 to Step S119 are executed instead of Step S102 to Step S104.

### Step S114

In Step S114, the third data processing device 30 searches the material of the invention with a question regarding the content of the invention in the processing portion 140. Accordingly, the search result of the material of the invention is obtained.

Note that examples of the question regarding the content of the invention include “what is the technical field?” and “what is the problem of the invention?”. The specific question content is preferably set by the user. In addition, a plurality of the question regarding the content of the invention can be set, and Step S114 to Step S117 are repeatedly executed as many times as the number of the questions.

### Step S115

In Step S115, the third data processing device 30 creates the fourth instruction sentence from the search result of the material of the invention in the processing portion 140.

The fourth instruction sentence is a character string for making the language model generate element information of the invention. Examples of the character string include a question regarding the content of the invention described above and the search result of the material of the invention.

### Step S116

In Step S116, the third data processing device 30 transmits the fourth instruction sentence to the first data processing device 10 through the output portion 120. The first data processing device 10 inputs the fourth instruction sentence to the language model and obtains a fourth answer sentence including the element information of the invention. The third data processing device 30 obtains the element information of the invention through the reception portion 110.

### Step S117

In Step S117, the third data processing device 30 stores the element information of the invention in the memory portion 130.

### Step S118

In Step S118, in the third data processing device 30, the process returns to Step S114 when the question regarding the content of the invention in Step S114 is not final, and the process proceeds to Step S119 when the question is final.

### Step S119

In Step S119, the third data processing device 30 creates the key point of the invention from the accumulated element information of the invention. Here, the key point of the invention may be a list of the element information of the invention or a table showing the element information. The third data processing device 30 transmits the key point of the invention to the information terminal 40, and the information terminal 40 outputs the key point of the invention.

### Variation Example 4 of Text Generation Method

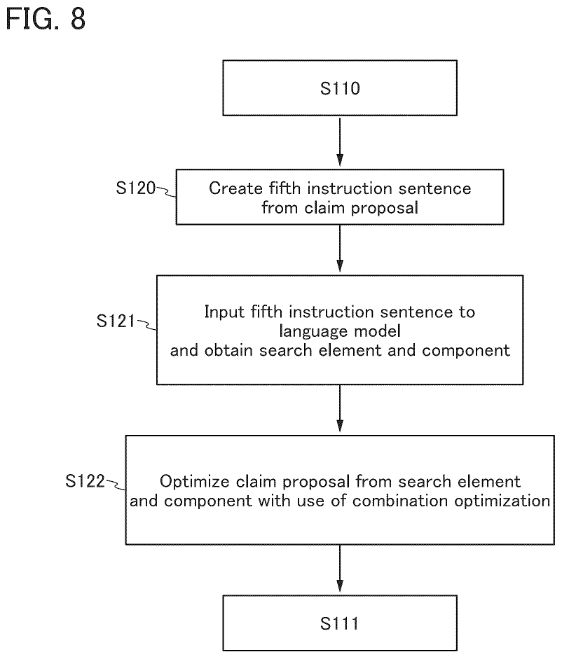

FIG. 8 is a flowchart of a variation example of the text generation method. In FIG. 8, Step S120 to Step S122 are executed between Step S110 and Step S111.

### Step S120

In Step S120, the third data processing device 30 creates a fifth instruction sentence from the claim proposal in the processing portion 140.

The fifth instruction sentence is a character string for making the language model generate a component of the invention and the search element. Examples of the fifth instruction sentence include a character string “extract a component of the invention from the following claim and create a search element corresponding to each component” and a character string including the claim proposal.

### Step S121

In Step S121, the third data processing device 30 transmits the fifth instruction sentence to the first data processing device 10 through the output portion 120. The first data processing device 10 inputs the fifth instruction sentence to the language model and obtains a fifth answer sentence including the component of the invention and the search element. The third data processing device 30 obtains the component of the invention and the search element through the reception portion 110.

A component of the invention is a technical feature of a claim and a search element is a character string for searching for the technical feature.

### Step S122

In Step S122, the third data processing device 30 performs combination optimization of components using the search element in the processing portion 140. For the combination optimization, a genetic algorithm is preferably used, for example.

For example, in the text generation method, the components of the invention are randomly selected and combined, combination optimization for searching for an appropriate combination of the components is executed, and the appropriate combination is searched with the use of the genetic algorithm.

For example, in the text generation method, it is preferable to use the number of search results of the patent search results obtained in Step S110 by a combination of search elements as the degree of suitability of the genetic algorithm for optimizing the claim proposal. Here, it is preferable that a search for a combination having the smallest number of search results be performed with few components, an optimal combination of components be set as an independent claim of the claims, and the remaining combination be set as a dependent claim of the claims.

### Variation Example 5 of Text Generation Method

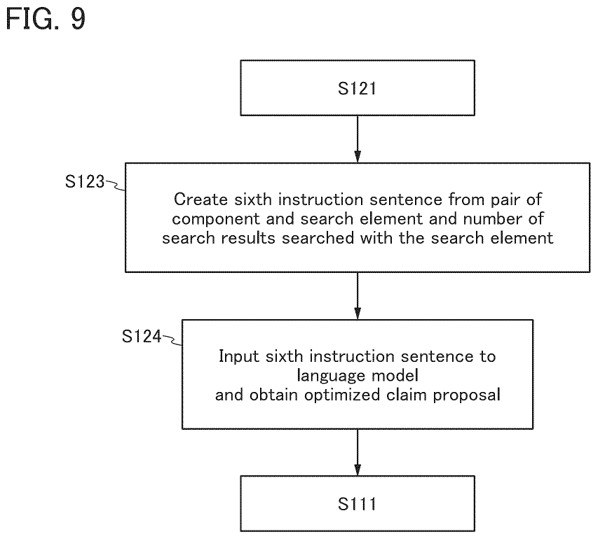

FIG. 9 is a flowchart of a variation example of the text generation method. In FIG. 9, Step S123 and Step S124 are executed instead of Step S122.

### Step S123

In Step S123, the third data processing device 30 creates a sixth instruction sentence from a pair of the component and the search element and the number of patent search results searched with the search element in the processing portion 140.

The sixth instruction sentence is a character string for making the language model optimize the claim proposal. Examples of the sixth instruction sentence include a character string “optimize the claim proposal using a pair of a component and a search element and the number of patent search results searched with the search element” and a character string including the claim proposal, the pair of the component and the search element, and the number of the patent search results.

### Step S124

In Step S121, the third data processing device 30 transmits the sixth instruction sentence to the first data processing device 10 through the output portion 120. The first data processing device 10 inputs the sixth instruction sentence to the language model and obtains the sixth answer sentence including the optimized claim proposal. The third data processing device 30 obtains the optimized claim proposal through the reception portion 110.

With such a text generation method of one embodiment of the present invention, it is possible to support description of claims. Furthermore, an appropriate patent search can be performed for the invention.

This application is based on Japanese Patent Application Serial No. 2024-123610 filed with Japan Patent Office on Jul. 30, 2024, the entire contents of which are hereby incorporated by reference.

What is claimed is:

1. A text generation system comprising:
a first data processing device;
a second data processing device; and
a third data processing device,
wherein the first data processing device is configured to receive at least a first instruction sentence, a second instruction sentence, and a third instruction sentence, perform processing using a language model, and output at least a first answer sentence, a second answer sentence, and a third answer sentence,
wherein the second data processing device is configured to receive a search formula, perform a patent search, and output a patent search result, and
wherein the third data processing device is configured to:
receive material of the invention;
create the first instruction sentence from the material of the invention;
transmit the first instruction sentence to the first data processing device and receive the first answer sentence comprising a key point of the invention;
output the key point of the invention;
create the second instruction sentence from the material of the invention and the key point of the invention;
transmit the second instruction sentence to the first data processing device and the second answer sentence comprising a claim proposal;
create the third instruction sentence from the claim proposal;
transmit the third instruction sentence to the first data processing device and receive the third answer sentence comprising the search formula; and
transmit the search formula to the second data processing device and receive the patent search result.

2. The text generation system according to claim 1,
wherein the third data processing device is configured to:
perform a search on the material of the invention for content of the invention and obtain a search result of the material of the invention;
create a fourth instruction sentence from the search result of the material of the invention;
transmit the fourth instruction sentence to the first data processing device and receive a fourth answer sentence comprising element information of the invention from the first data processing device;
accumulate the element information of the invention; and
create the key point of the invention from the element information of the invention.

3. The text generation system according to claim 1,
wherein the third data processing device is configured to:
create a fifth instruction sentence from the claim proposal;
transmit the fifth instruction sentence to the first data processing device and receive a fifth answer sentence comprising a search element and a component from the first data processing device; and
optimize the claim proposal using combination optimization of the search element and the component.

4. The text generation system according to claim 1,
wherein the third data processing device is configured to:
create a fifth instruction sentence from the claim proposal;
transmit the fifth instruction sentence to the first data processing device and receive a fifth answer sentence comprising a search element and a component from the first data processing device;
create a sixth instruction sentence from a pair of the search element and the component and number of patent search results searched with the search element; and
transmit the sixth instruction sentence to the first data processing device and receive a sixth answer sentence comprising the optimized claim proposal from the first data processing device.

5. A text generation method comprising:
a first step, a second step, a third step, a fourth step, a fifth step, a sixth step, a seventh step, an eighth step, a ninth step, a tenth step, and an eleventh step,
wherein in the first step, material of an invention is received,
wherein in the second step, a first instruction sentence is created from the material of the invention,
wherein in the third step, the first instruction sentence is input to a language model and a first answer sentence comprising a key point of the invention is obtained,
wherein in the fourth step, the key point of the invention is output to a user,
wherein in the fifth step, the key point of the invention modified by the user is received,
wherein in the sixth step, a second instruction sentence is created using the material of the invention and the modified key point of the invention,
wherein in the seventh step, the second instruction sentence is input to the language model and receive a second answer sentence comprising a claim proposal is obtained,
wherein in the eighth step, a third instruction sentence is created from the claim proposal,
wherein in the ninth step, the third instruction sentence is input to the language model and a third answer sentence comprising a search formula is obtained,
wherein in the tenth step, the search formula is input to a search server and a patent search result is obtained,
wherein in the eleventh step, the patent search result and the claim proposal are output to the user, and
wherein the first step, the second step, the third step, the fourth step, the fifth step, the sixth step, the seventh step, the eighth step, the ninth step, the tenth step, and the eleventh step are executed in the above order by a processing portion.

6. The text generation method according to claim 5, further comprising a twelfth step,
wherein the twelfth step is executed after the tenth step,
wherein in the twelfth step, whether number of documents of the patent search result is within a predetermined range is determined, and a process returns to the eighth step when the number of the documents of the patent search result is not within the predetermined range, and
wherein the process proceeds to the eleventh step when the number of the documents of the patent search result is within the predetermined range.

7. The text generation method according to claim 5, further comprising a thirteenth step,
wherein the thirteenth step is executed after the eleventh step, and
wherein in the thirteenth step, the user confirms the patent search result and the claim proposal, and a process returns to the fifth step when modification of the claim proposal is necessary, and execution of the steps is terminated when modification of the claim proposal is not necessary.

8. The text generation method according to claim 5,
wherein a fourteenth step, a fifteenth step, a sixteenth step, a seventeenth step, an eighteenth step, and a nineteenth step are included instead of the second step, the third step, and the fourth step,
wherein in the fourteenth step, a search for the material of the invention using a question regarding content for the invention is performed and a search result of the material of the invention is obtained,
wherein in the fifteenth step, a fourth instruction sentence is created from the search result of the material of the invention,
wherein in the sixteenth step, the fourth instruction sentence is input to the language model and a fourth answer sentence comprising element information of the invention is obtained,
wherein in the seventeenth step, the element information of the invention is accumulated,
wherein in the eighteenth step, the fourteenth step, the fifteenth step, the sixteenth step, and the seventeenth step are repeated until the final question, and
wherein in the nineteenth step, the accumulated element information of the invention is output as the key point of the invention.

9. The text generation method according to claim 5, further comprising a twentieth step, a twenty-first step, and a twenty-second step after the eleventh step,
wherein in the twentieth step, a fifth instruction sentence is created from the claim proposal,
wherein in the twenty-first step, the fifth instruction sentence is input to the language model and a fifth answer sentence comprising a search element and a component is obtained, and
wherein in the twenty-second step, the claim proposal is optimized using combination optimization of the search element and the component.

10. The text generation method according to claim 9, further comprising a twenty-third step and a twenty-fourth step instead of the twenty-second step,
wherein in the twenty-third step, a sixth instruction sentence is created from a pair of the component and the search element and number of patent search results searched with the search element, and
wherein in the twenty-fourth step, the sixth instruction sentence is input to the language model and a sixth answer sentence comprising the optimized claim proposal is obtained.
